(19) United States
(12) Patent Application Publication
(10) Pub. No.: US 2006/0005925 A1
(43) Pub. Date: Jan. 12, 2006

(54) Method for producing thermoplastic resin laminated sheet

(75) Inventors: Noriaki Hase, Niihama-shi (JP); Kouichirou Watanabe, Niihama-shi (JP); Takayuki Nojima, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignees: SUMITOMO CHEMICAL COMPANY, LIMITED; NOF CORPORATION

(21) Appl. No.: 11/176,221

(22) Filed: Jul. 8, 2005

(30) Foreign Application Priority Data
Jul. 12, 2004 (JP) P2004-204282

(51) Int. Cl. B29C 65/00; B29C 47/00; B32B 37/00; B32B 37/14

(52) U.S. Cl. 156/324; 156/244.12; 156/499; 156/555

(57) ABSTRACT

There is provided a method for producing a thermoplastic resin laminated sheet in which a thermoplastic resin film is bonded to a thermoplastic resin sheet with the sufficient adhesion, and such laminated sheet is obtained by sandwiching the thermoplastic resin film and the thermoplastic resin sheet between lamination rolls while each of their surfaces to be laminated has a temperature within a predetermined specific range, followed by pressing them.

### BACKGROUND OF THE INVENTION

1. Field of the Invention

The present invention relates to a method for producing a thermoplastic resin laminated sheet, and particularly to a method for producing a thermoplastic resin laminated sheet in which a thermoplastic resin film is laminated onto a thermoplastic resin sheet by means of heat-welding.

2. Description of the Background Art

Japanese Laid-open Patent Publication No. 06-126854/1994 discloses a production method of a thermoplastic resin laminated sheet (which is also referred to as merely a “laminated sheet”) (A) as shown in FIG. 5 wherein a thermoplastic resin film (which is also referred to as merely a “film”) (F) is laminated onto one side (as shown in FIG. 4(a)) or each side (as shown in FIG. 4(b)) of a thermoplastic resin sheet (which is also referred to as merely a “sheet”) (S), and such method comprises superimposing, on the sheet (S) in its heated state, the film (F) as it is which is heat-weldable to the sheet (S) without heating the film (F) as shown in FIG. 5 and sandwiching them between a pair of lamination rolls (21, 22) followed by pressing them with the rolls (21, 22) so as to heat-weld them together.

The above production method does not always provide a laminated sheet (A) which has a satisfactory bonding strength between the sheet (S) and the film (F). For example, when the laminated sheet (A) is cut using a saw, the film (F) is readily delaminated at a cut surface.

### SUMMARY OF THE INVENTION

Thus, the inventors of the present application have made intensive studies so as to develop a method which is capable of readily producing a thermoplastic resin laminated sheet where in a film (F) is laminated onto a sheet (S) with a sufficient adhesion. As a result, the inventors have found that a laminated sheet in which a film (s) is bonded to a sheet (S) with the sufficient adhesion is obtained by sandwiching them between lamination rolls while each of their surfaces to be laminated (that is, a lamination surface of the sheet (S) and a lamination surface of the film (F)) has a temperature within a predetermined specific range followed by pressing them, and thereby the present invention has been completed.

That is, the present invention provides a method for producing a thermoplastic resin laminated sheet (A) in which a thermoplastic resin film (F) is laminated on at least one surface of a thermoplastic resin sheet (S), said method comprising the steps of:

superimposing the thermoplastic resin film (F) on the thermoplastic resin sheet (S) which is in a heated state;

sandwiching them between a pair of lamination rolls (21, 22); and

pressing them by the lamination rolls (21, 22) so as to heat-weld them together

wherein, at the sandwiching step, the thermoplastic resin sheet (S) has a lamination surface (Sa) having a temperature (Ts) which satisfies the following inequality (I):
Tgs+5° C.≦Ts≦Tgs+40° C. (I)

(wherein “Ts” is a temperature of the lamination surface (Sa) of the thermoplastic resin sheet (S), and “Tgs” is a glass transition temperature of the lamination surface (Sa) of the thermoplastic resin sheet (S)); and

the thermoplastic resin film (F) has a lamination surface (Fa) having a temperature (Tf) which satisfies the following inequalities (II) and (III):
Tgf−15° C.≦Tf≦Tgf+40° C. (II)
(wherein “Tf” is a temperature of the lamination surface (Fa) of the thermoplastic resin film (F), and “Tgf” is a glass transition temperature of the lamination surface (Fa) of the thermoplastic resin film (F)), and
Tf≧Tgf+Tgs−Ts (III)

(wherein Ts, Tf, Tgs and Tgf have the meanings as defined above).

The method according to the present invention may be carried out using an apparatus as shown as one example in FIG. 1 for producing the thermoplastic resin laminated sheet (A) in which the thermoplastic resin film (F) is laminated on at least one side of the thermoplastic resin sheet (S). The apparatus (1) comprises a pair of the lamination rolls (21, 22) with which the thermoplastic resin sheet (S) and the thermoplastic resin film (F) superimposed thereon are sandwiched and pressed so that they are heat-welded together, whereby the thermoplastic resin laminated sheet (A) can be produced. The apparatus further comprises a heater (8) which heats the thermoplastic resin film (F) such that the temperature (Tf) of the lamination surface (Fa) of the film (F) satisfies the above inequalities (II) and (III). In addition, the apparatus may comprise a heater for heating the thermoplastic resin sheet (S) such that the temperature (Ts) of the lamination surface (Sa) of the sheet (S) satisfies the above inequality (I). Alternatively, the lamination rolls (21, 22) may have a function serving as a heater. It is noted that the apparatus (1) is configured such that the thermoplastic resin film (F) which is heated by means of the heater (8) is superimposed on the thermoplastic resin sheet (S) and they are sandwiched between and by the rollers (21, 22). Thus, the present invention also provides an apparatus which carries out the method according to the present invention, wherein the apparatus comprises a heater (8) by which a temperatures (Tf) of a lamination surface of a thermoplastic resin film (F) is controlled, and an optional heater by which a temperatures (Ts) of a lamination surface of a thermoplastic resin sheet (S) is controlled, so as to satisfy the inequalities (I), (II) and (III).

According to the present invention, the thermoplastic resin laminated sheet is provided wherein the thermoplastic resin film is bonded to the thermoplastic resin sheet with the sufficient adhesion.

### BRIEF DESCRIPTION OF THE DRAWINGS

FIG. 1 schematically shows one example of an apparatus for producing a thermoplastic resin laminated sheet according to the present invention.

FIG. 2 schematically shows another example of an apparatus for producing a thermoplastic resin laminated sheet according to the present invention.

FIG. 3 schematically shows a further example of an apparatus for producing a thermoplastic resin laminated sheet according to the present invention.

FIG. 4(a) and FIG. 4(b) show elements which form thermoplastic resin laminated sheets respectively.

FIG. 5 schematically shows one example of an apparatus for producing a thermoplastic resin laminated sheet according to a conventional method.

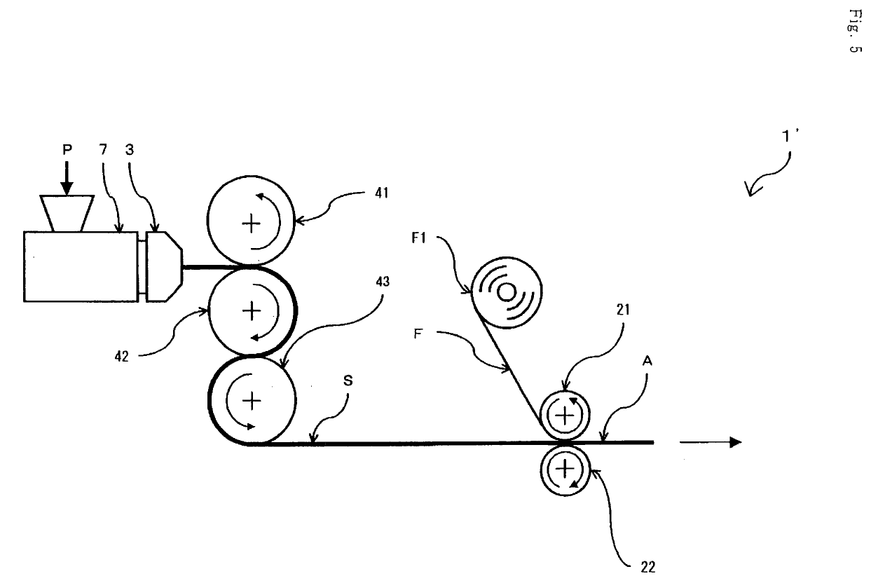

In the drawings, reference numbers or alphabets indicate the following elements:

1, and 1′ apparatus for producing thermoplastic resin laminated sheet

3 die

5 heater for heating sheet

6 holding mechanism (guide rolls)

7 extruder

8 heater for heating film

21, 22 lamination roll

41 first calender roll

42 second calender roll

43 third calender roll

91, 92 draw roll

A thermoplastic resin laminated sheet

C contact peripheral length (arc length)

F thermoplastic resin film

F1 raw film roll

Fa lamination surface

Fb non-lamination surface

Fh surface treatment layer

p thermoplastic resin

S thermoplastic resin sheet

Sa lamination surface

Sb non-lamination surface

### DETAILED DESCRIPTION OF THE INVENTION

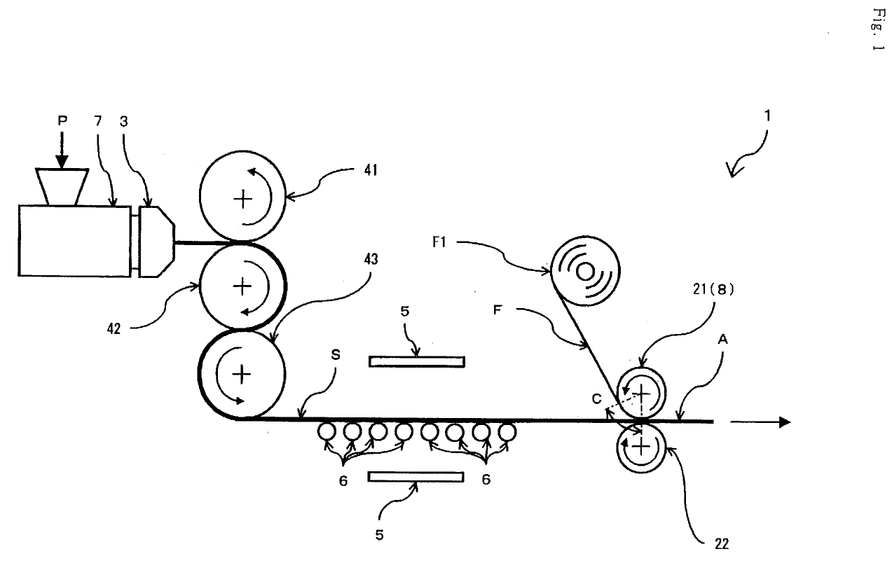

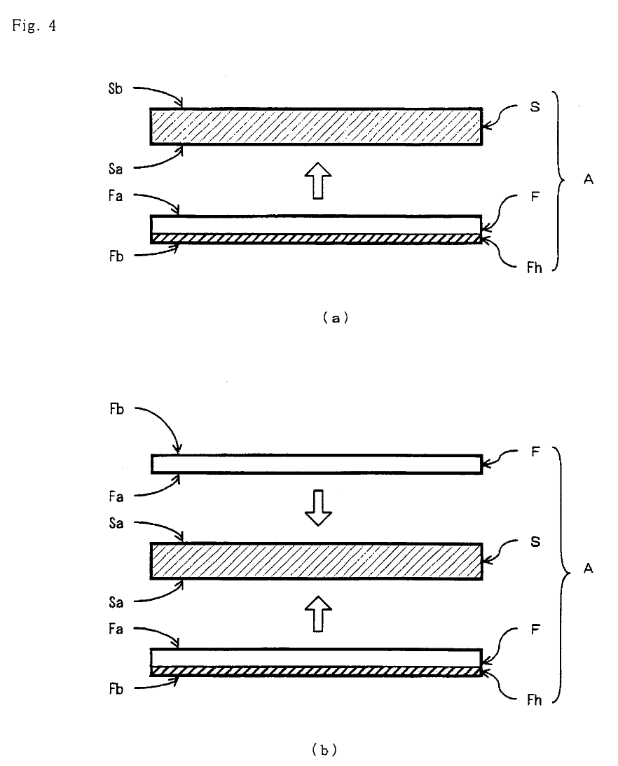

Referring to FIGS. 1 to 4, the present invention, and particularly the method thereof will be explained in detail below. Each of FIGS. 1 to 3 schematically shows an example of an apparatus with which the method according to the present invention is carried out so as to produce the thermoplastic resin laminated sheet (A). FIG. 4 schematically shows layer structures of the thermoplastic resin laminated sheets (A) produced by the production method according to the present invention.

The thermoplastic resin sheet (S) used in the production method according to the present invention comprises a thermoplastic resin. Examples of the thermoplastic resin which forms the sheet (S) include an acrylic resin, a styrene resin, a methyl methacrylate-styrene copolymer resin, a polycarbonate resin, an acrylonitrile-butadiene-styrene terpolymer resin (ABS resin), an acrylonitrile-styrene copolymer resin (AS resin), a vinyl chloride resin, a polyolefin resin such as a polyethylene and a polypropylene, a polyester resin, a polyacetal resin, a fluororesin such as a polyvinylidene fluoride (PVDF), a nylon resin, and others. Such a thermoplastic resin may include an additive such as a heat stabilizer, an anti-oxidant, a light stabilizer, an ultraviolet absorber, a colorant, a plasticizer, and an antistatic agent. Further, the thermoplastic resin may contain elastic particles. Two or more kinds of thermoplastic resins may be used to prepare the thermoplastic resin sheet (S)

As the thermoplastic resin sheet (S) as described, for example a thermoplastic continuous sheet (S) may be used which is continuously produced in an extrusion process in which the thermoplastic resin (P) is heated and melted and then extruded through a die (3) as shown in FIGS. 1 to 3.

In order to heat and melt the thermoplastic resin (P), an extruder (7) maybe utilized. The thermoplastic resin (P) is heated and melted while being kneaded by the extruder (7), so that the resin in a molten state is supplied to the die (3).

The thermoplastic resin in the heated and molten state is continuously extruded through the die (3) into a sheet form so that a thermoplastic resin continuous sheet (S) is formed. For example, a T-die may be used as the die (3). The die (3) may extrude the thermoplastic resin (P) to be in a monolayer form, or in a multilayer form such as a two-layer form or a three-layer form. By using the die that extrudes the thermoplastic resin (P) to be in the monolayer form, a monolayer thermoplastic resin sheet (S) is obtained. By coextruding two or more kinds of the thermoplastic resins with a die for extruding the resins in the multilayer form, a multilayer thermoplastic resin sheet (S) is obtained.

The thermoplastic resin sheet (S) which is extruded from the die (3) maybe directly inserted between the lamination rolls (21, 22) as it is so as to use it for the lamination with a film (F). Alternatively, the thermoplastic resin sheet (S) which is extruded from the die (3) may be rolled by calender rolls (41, 42, 43) followed by the lamination as shown in FIGS. 1 to 3. When the sheet (S) is rolled, the diameter of the calender rolls (41, 42, 43) may be not smaller than about 15 cm and not larger than about 60 cm. The number of the calender rolls (3) is not particularly limited as long as the number is two or more which number allows the calender rolls (3) to sandwich and roll the thermoplastic resin sheet (S). In the apparatus (1) shown in FIGS. 1 to 3, three calender rolls (41, 42, 43) are used. With the shown production apparatus (1), the thermoplastic resin sheet (S) extruded from the die (3) is first rolled by being sandwiched between the first calender roll (41) and the second calender roll (42), and then further rolled again by being sandwiched between the second calender roll (42) and the third calender roll (43) while being wound and hung onto the second calender roll (42). The thermoplastic resin sheet (S) is in the heated state immediately after being extruded from the die (3) or immediately after being rolled by the calender rolls (41, 42, 43), and a temperature (Ts) of its lamination surface(s) (Sa) may be within the range between [Tgs−20° C.] and [Tgs+20° C.] wherein Tgs is a glass transition temperature of the lamination surface (Sa) of the sheet (S)

It is noted that the glass transition temperature in the present invention is intended to mean the conventional glass transition temperature used in the field of the present invention, and it is measured according to JIS K 7121 which corresponds to ASTM D 3418.

The thermoplastic resin sheet (S) may have a thickness in the range between about 1 mm and about 20 mm, and a width in the range between about 200 mm and about 2500 mm.

The thermoplastic resin film (F) used in the production method according to the present invention comprises a thermoplastic resin. A thermoplastic resin continuous film which has been unwound up to be a raw film roll (F1) may be used while being wound out from the roll (F1). Alternatively, the film (F) may be in the form of a leaf film. When the film (F) is in the leaf form, the film (F) may be inserted into the gap between the lamination rolls (21, 22) one by one. Examples of the thermoplastic resin which forms the film (F) include, as similarly to the above mentioned thermoplastic resin for the sheet (S), an acrylic resin, a styrene resin, a methyl methacrylate-styrene copolymer resin, a polycarbonate resin, an ABS resin, a vinyl chloride resin, a polyolefin resin, a polyester resin, a polyacetal resin, a fluororesin resin, a nylon resin and so on.

The thermoplastic resin film (F) may contain an additive such as a heat stabilizer, an anti-oxidant, a light stabilizer, an ultraviolet absorber, a colorant, a plasticizer, and an antistatic agent. In addition, the film (F) may contain elastic particles. The thermoplastic resin film (F) that contains the elastic particles tends to be excellent in its flexibility so that it can be readily handled, which is preferable when the film is used. Examples of the elastic particles include acrylic ester copolymer resin particles, polybutadiene rubber particles, styrene-butadiene copolymer rubber particles, butadiene-acrylic ester copolymer rubber particles, and others.

The thermoplastic resin film (F) may be a monolayer film made of a single layer or may be a multilayer film in which two or more kinds of layers are laminated. The thickness of the film (F) may be smaller than that of the sheet (S) and in the range between about 50 μm and about 1000 μm, and the width of the film (F) may be similar to or of the same as that of the thermoplastic resin sheet (S).

As the thermoplastic resin film (F), a film is used which has a heat-weldable property to the sheet (S), that is, which is capable of being laminated onto the thermoplastic resin sheet (S) by means of heat-welding. For example, the film (F) may be a film having a lamination surface (Fa) made of a material which is the same as that of the lamination surface (Sa) of the thermoplastic resin sheet (S). Further, when the lamination surface (Sa) of the sheet (S) is made of an acrylic resin or a methyl methacrylate-styrene copolymer resin, the film (F) may be a film having a lamination surface (Fa) made of an acrylic resin, a methyl methacrylate-styrene copolymer resin, a styrene resin, an ABS resin, a fluororesin, a nylon resin, or the like. The lamination surface (Fa) of the film (F) maybe subjected to a surface treatment so as to facilitate heat-welding with the thermoplastic resin sheet (S).

The non-lamination surface (Fb) (that is, the other surface as to the lamination surface (Fa)) of the thermoplastic resin film (F) may have at least one surface treatment layer (Fh) disposed thereon. Such surface treatment layer may also be referred to as a functional cover layer since it imparts a desired function to the film (F). Examples of such a surface treatment layer. (Fh) include a hard coat layer which increases surface hardness, an anti-reflection layer which suppresses surface reflection of visible light, an antidazzle layer which provides with a glare proof property, a light cut-off layer which intercepts a light having a specific wavelength, an antistatic layer which provides with an antistatic property, a electrically conductive layer which provides with electric conductivity, a color tone correction layer which adjusts color tone, a cohesion layer which improves adhesion between the film (F) and a surface treatment layer as described above, or between two surface treatment layers when a plurality of the surface treatment layers are used. The surface treatment layer (Fh) may have a thickness in the range between about 0.1 μm and about 50 μm.

The optional hard coat layer maybe formed as a single layer, and may be for example a cured layer which is formed by curing (or polymerizing) of multifunctional monomers. For example, the following layers may be exemplified:

a cured layer formed by curing at least one multifunctional polymerizable compound having at least two selected from an acryloyl group and a methacyloyl group (such as a urethane acrylate, a polyester acrylate, a polyether acrylate, a urethane methacrylate, a polyester methacrylate, a polyether methacrylate and the like) by means of activating energy ray such as an ultraviolet ray, an electron ray, or the like; and

a cured layer formed by heating so as to harden with cross-linking a layer comprising a silicone based material, a melamine based material or an epoxy based material, which is a cross-linkable raw material for a resin.

Particularly, a cured layer formed by curing to polymerize a urethane acrylate and a cured layer made from a silicone based cross-linkable raw material for a resin are excellent from viewpoints of durability and handling of the layer. The hard coat layer may have a thickness in the range between about 1 μm and about 20 μm.

The optional anti-reflection layer may be of a monolayer structure having a single layer alone which has a low refractive index, or of a multilayer structure having a plurality of layers such as a two layer structure which has a high refractive index layer and a low refractive index layer; a three layer structure which has a medium refractive index layer, a high refractive index layer and a low refractive index layer, a four layer structure which has a high refractive index layer, a low refractive index layer, a high refractive index layer and a low refractive index layer. It is noted that the above refractive index layers are indicated in the order of their positions from the closest to the film (F) to the remotest from the film (F). In the case where the anti-reflection layer is provided as the surface treatment layer (Fh), when other layer, for example, the hard coat layer is preferably further provided, so that said other layer is usually located between the anti-reflection layer and the film (F). Particularly, the presence of the hard coat layer between the anti-reflection layer and the film (F) is preferable since the surface hardness is improved.

The surface treatment layer (Fh) as described above may be formed by any conventional coating technique such as wet coating methods, dry coating methods and the like. The wet coating methods are preferable from viewpoints of the productivity and the production cost, and among them, the roll coating manner is more preferable because it allows continuous formation of the surface treatment layer.

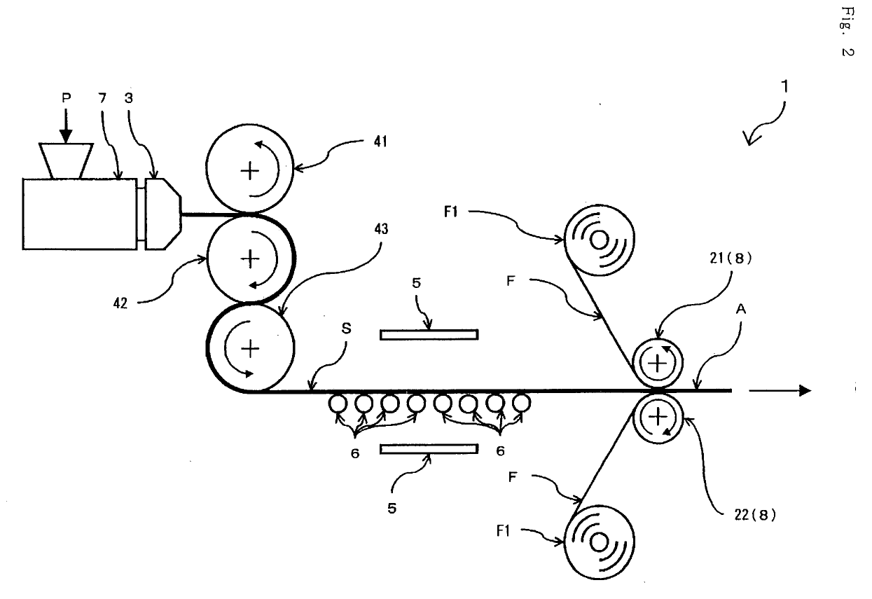

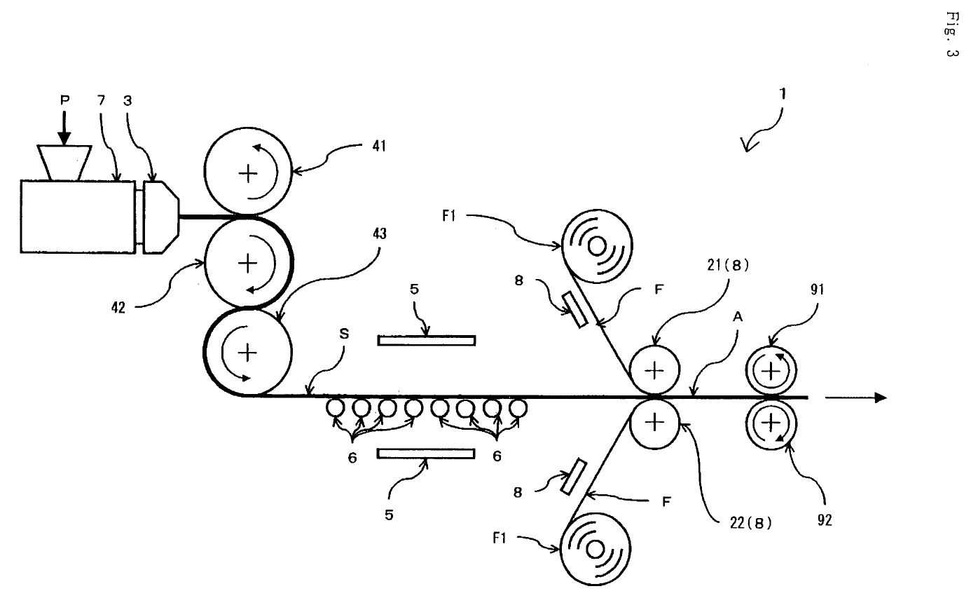

The thermoplastic resin film (F) as described above may be laminated onto one side of the thermoplastic resin sheet (S) as shown in FIG. 1 or to each side of the thermoplastic resin sheet (S) as shown in FIGS. 2 and 3.

In the method according to the present invention, after the thermoplastic resin film (F) is superimposed on the thermoplastic resin sheet (S), they are inserted into a gap between a pair of the lamination rolls (21, 22) so that they are sandwiched by the rolls. The lamination rolls (21, 22) are rolls which sandwich and press the sheet (S) and the film 65 (F) so that the they are laminated together.

The diameter of the lamination rolls (21, 22) may be in the range between about 5 cm and about 30 cm. Surfaces of the lamination rolls (21, 22) may be of a metal such as a stainless steel, but the surfaces are preferably made of a rubber from a viewpoint of protecting a non-lamination surface (Fb) of the film (F). Such roll may be referred to as a rubber roll. As a rubber material which forms the surface of the rubber roll, a silicone rubber, a butyl rubber, and an ethylene-propylene-diene terpolymer rubber (EPDM rubber) may be exemplified.

The lamination rolls (21, 22) may be drawing rolls as shown in FIGS. 1 and 2 which themselves rotate by means of driven mechanisms such as motors (not shown) so as to draw the sheet (S) and the film (F), or they may be free rolls as shown in FIG. 3 which themselves are not driven but rotate in synchronization with draw rolls (91, 92) which are driven by means of driven mechanisms (not shown) so as to draw the laminated sheet (A) after the lamination.

The sheet (S) and the film (F) sandwiched between the pair of the rolls (21, 22) are pressed by those roll (21, 22). In view of sufficient heat-welding, the pressing is preferably conducted with a line pressure of not smaller than 500 N/m (about 50 kgf/m). Further, when the film (F) has the surface treatment layer (Fh) on its non-lamination surface (Fb), and especially when such surface treatment layer (Fh) comprises the anti-reflection layer and/or the hard coat layer, the pressing is preferably conducted with a line pressure of not larger than 3000 N/m (about 300 kgf/m) to prevent any damage (such as crack) of the surface treatment layer (Fh).

In the method according to the present invention, the thermoplastic resin sheet (S) has the lamination surface (Sa) having a temperature (Ts) which meets the above inequality (I), the thermoplastic resin film (F) has the lamination surface (Fa) having a temperature(Tf) which meets the above inequalities (II) and (III), while the sheet (S) and the film (F) are sandwiched by the lamination rolls (21, 22). When the sheet has a lamination surface (Sa) having a temperature (Ts) which is lower than (Tgs+5° C.), or when the film has a lamination surface (Fa) having a temperature (Tf) which is lower than (Tgf−15° C.) or which does not meet the inequality (III), it may be difficult to obtain a lamination with the sufficient adhesion. Also, when the sheet has a lamination surface (Sa) having a temperature (Ts) which is higher than (Tgs+40° C.), or when the film has a lamination surface (Fa) having a temperature (Tf) which is higher than (Tgf+40° C.) it tends to be difficult to conduct the pressing by means of the lamination rolls (21, 22).

In order that the thermoplastic resin sheet has a lamination surface having a temperature (Ts) which meets the inequality (I), the sheet (S) maybe heated by means of a sheet heater (5) as shown in FIGS. 1 to 3. As the sheet heater (5), any conventional heater maybe used such as an electric heater, an infrared heater, a warm air heater and the like. The lamination surface (Sa) of the thermoplastic resin sheet (S) is typically heated. When the both surfaces of the sheet (S) are laminated with the films (F), the both surfaces of the sheet (S) are typically heated. When one surface of the sheet is to be laminated with the film, only said one surface of the sheet as the lamination surface (Sa) may be heated, or the both surfaces of the sheet (S) may be heated.

When the sheet (S) is rolled by the calender roll(s), it may be heated while being passed around the roll(s) (41, 42, 43). It is preferable that the sheet (S) which has left the roll (43) is heated while the sheet is kept flat since thus keeping step tends to produce a laminated sheet (A) which has a less warpage. In order to heat the sheet while keeping it in its flat state, for example a holding mechanism (6) may be used. The production apparatus (1) illustrated in FIGS. 1 to 3 uses as the holding mechanism (6) a plurality of guide rolls (6) which are arranged in parallel and horizontally. Such guide rolls (6) may be, for example, commercially available ones which are sold as a roller table. The sheet (S) is preferably conveyed while being held flat by the holding mechanism (6), during which it is heated by the heater. It is noted that the sheet (S) does not necessarily need to be held exactly flat, and may be held generally so flat that no stress may remain.

The surface temperature (Ts) of the sheet (S) which is just after leaving the die (3) or the sheet (S) which is just after being rolled by the calender rolls (41, 42, 43) as shown in FIGS. 1 to 4 may be already within the range of the inequality (I), and in such case, the sheet (S) may be inserted into the gap between the rolls (21, 22) as it is without being heated.

In order that the film (F) has a lamination surface (Fa) having a temperature (Tf) which satisfies the inequalities (II) and (III), a heater (heating means) (8) in the production apparatus (1) may be used to heat the film (F) as shown in FIGS. 1 to 3.

In the production apparatus (1) shown in FIG. 1, one (21) of the lamination rolls (21, 22) contacts with the film (F)and is heated by induction heating or a heater to serve as a heater (8) for heating the film (F). In the production apparatus (1) shown in FIG. 2, the pair of the rolls (21, 22) respectively contact with the films (F), and may serve as the heaters (8) for heating the films (F). The roll(s) (21, 22) is/are heated to be heater(s) (i.e. heating roll(s)) for heating the film(s) (F), whereby the film(s) (F) maybe heated while being passed around and in contact with the roll(s) (21, 22). Thus heated film(s) (F) is/are inserted as it is into the gap between the rolls (21, 22).

The contact peripheral length (C) with which the film (F) contacts with the roll (21) up to being sandwiched by the rolls (21, 22) (see the two-headed arrow in FIG. 1) is sufficiently long so that the lamination surface (Fa) of the film (F) has a temperature (Tf) which satisfies the inequalities (II) and (III). When the film (F) is heated by the lamination roll (21) with the contact peripheral length (C) in the range between 20 mm to 300 mm while being passed around the roll, a laminated sheet (A) having a film (F) with less wrinkle, of which lateral shrinkage ratio maybe not larger than 20%, can be readily produced, which is preferred.

In the production apparatus (1) shown in FIG. 3, the heater (8) for heating the film is provided between the raw material roll (F1) and the lamination roll (21). As such a heater (8), any conventional one may be used such as an electric heater, an infrared heater, a warm air heater and the like. When the thermoplastic resin film (F) is heated with such heater (8), the film may be heated from a side of the lamination surface (Fa) which is to be laminated with the sheet (S). Alternatively, the film may be heated from a side of the non-lamination surface (Fb) as far as the temperature (Tf) of the lamination surface satisfies the inequalities (II) and (III).

As to the thermoplastic laminated sheet (A) produced by the method according to the present invention, the thermoplastic resin film(s) (F) is bonded to the thermoplastic resin sheet (S) with the sufficient adhesion. Thus, even when the laminated sheet (A) is cut using for example an electric saw, delamination of the film (F) from the sheet (S) is rarely observed.

The present invention will be explained further in detail by way of examples. The present invention is however not limited to those examples as well as the above examples. In each of the following examples, a lamination surface temperature (Ts) of an acrylic resin sheet and a lamination surface temperature (Tf) of an acrylic resin film, both of which were just before being sandwiched by lamination rolls, were measured by an infrared-ray radiation thermometer (“IT2-80” manufactured by Keyence Corporation).

### EXAMPLES

### Example 1

As shown in FIG. 1, an acrylic resin (P) having a glass transition temperature (Tgs) of 105° C. was heated, melted and kneaded by an extruder (7), and extruded through a die (3), followed by rolling with the three calender rolls (41, 42, 43) each having a diameter of 200 mm, to obtain a continuous acrylic resin sheet (S) having a thickness of 2 mm and a width of 200 mm. Thus obtained sheet (S) was heated from its both surfaces by a far infrared heaters (5) while being held generally horizontally by means of the guide rolls (6), and the sheet (S) was supplied into the gap between a pair of the rolls (21, 22) each having a diameter of 100 mm. The power of the heaters (5) was controlled such that the lamination surface (Sa) of the acrylic resin sheet (S) had a temperature (Ts) of 115° C. just before being sandwiched by the lamination rolls (21, 22).

On the other hand, an acrylic resin continuous film (F) having a single acrylic resin layer with a glass transition temperature (Tgf) of 80° C. and a thickness of 125 μm without surface treatment was unrolled from the raw film material roll (F1), and it was passed around one (21) of the lamination rolls (21, 22) with the contact peripheral length (C) of 40 mm. Such film (F) was placed on one surface (Sa) of the above described acrylic resin continuous sheet (S), and then they were sandwiched by the lamination rolls (21, 22). The lamination roll (21) on which the film (F) was wound functioned as a heating roll, and the temperature of the roll (21) was controlled such that the lamination surface (Fa) of the acrylic resin film (F) just before being sandwiched had a temperature (Tf) of 110° C.

Using a pair of the lamination rolls (21, 22), thus sandwiched acrylic resin continuous sheet (S) and acrylic resin continuous film (F) were pressed together with a line pressure of about 2000 N/m so as to heat-weld them, whereby an acrylic resin laminated sheet (A) was produced in which the acrylic resin film (F) was laminated onto one surface (Sa) of the acrylic resin sheet (S) as shown in FIG. 4(a). No wrinkle was observed on the film (F) of the laminated sheet (A). The sheet (A) was cut into leaves. The laminated sheet in the leaf form was cut from a side of the non-lamination surface (Sb) having no film (F) thereon using an electric saw. No delamination of the film (F) was observed across the cut section.

### Example 2

Example 1 was repeated except that the power of the far infrared heaters (5) was controlled such that the lamination surface (Sa) of the acrylic resin sheet (S) had a temperature (Ts) of 120° C. just before being sandwiched by the lamination rolls while the temperature of the roll (21) was controlled such that the lamination surface (Fa) of the acrylic resin continuous film (F) had a temperature (Tf) of 70° C. just before being sandwiched by the lamination rolls, whereby an acrylic resin laminated sheet (A) was produced in which the acrylic resin film (F) was laminated onto one surface (Sa) of the acrylic resin sheet (S). No wrinkle was observed on the film (F) of the laminated sheet (A). As in Example 1, the sheet (A) was cut into the leaves, and the laminated sheet in the leaf form was cut using the electric saw. No delamination of the film (F) was observed across the cut section.

### Example 3

Example 1 was repeated except that the power of the far infrared heaters (5) was controlled such that the lamination surface (Sa) of the acrylic resin sheet (S) had a temperature (Ts) of 130° C. just before being sandwiched by the lamination rolls while the temperature of the rolls was controlled such that an acrylic continuous film (F) having single acrylic resin layer was used which layer had a glass transition temperature (Tgf) of 105° C. and a thickness of 125 μm without surface treatment in place of the film with the glass transition temperature of 80° C., whereby an acrylic resin laminated sheet (A) was produced in which the acrylic resin film (F) was laminated onto one surface (Sa) of the acrylic resin sheet (S). No wrinkle was observed on the film (F) of the laminated sheet (A). As in Example 1, the sheet (A) was cut into the leaves, and the laminated sheet in the leaf form was cut using the electric saw. No delamination of the film (F) was observed along the cut section.

### Example 4

Example 1 was repeated except that the power of the far infrared heater (5) was controlled such that the lamination surface (Sa) of the acrylic resin sheet (S) had a temperature (Ts) of 130° C. just before being sandwiched by the lamination rolls while an acrylic continuous film (F) (REALOOK 4700, manufactured by NOF Corporation) having a single acrylic resin layer which had a glass transition temperature (Tgf) of 105° C. with an anti-reflection layer (Fh) on the non-lamination surface (Fb) in place of the film with the glass transition temperature of 80° C. was used, whereby an acrylic resin laminated sheet (A) was produced in which the acrylic resin film (F) was laminated onto one surface (Sa) the acrylic resin sheet (S). No wrinkle was observed on the film (F) of the laminated sheet (A). As in Example 1, the sheet (A) was cut into the leaves, and the laminated sheet in the leaf form was cut using the electric saw. No delamination of the film (F) was observed across the cut section.

### Comparative Example 1

Example 1 was repeated except that the power of the far infrared heaters (5) was controlled such that the lamination surface (Sa) of the acrylic resin sheet (S) had a temperature (Ts) of 90° C. just before being sandwiched by the lamination rolls, whereby an acrylic resin laminated sheet (A) was produced in which the acrylic resin film (F) was laminated onto one surface (Sa) of the acrylic resin sheet (S). No wrinkle was observed on the film (F) of the laminated sheet (A). As in Example 1, the sheet (A) was cut into the leaves, and the laminated sheet in the leaf form was cut using the electric saw. Delamination of the film (F) was observed across the cut section.

### Example 5

As shown in FIG. 2, an acrylic resin (P) having a glass transition temperature (Tgs) of 105° C. was heated, melted and kneaded by an extruder (7), and extruded through a die (3), followed by rolling with the three calender rolls (41, 42, 43) each having a diameter of 200 mm, to obtain a continuous acrylic resin sheet (S) having a thickness of 2 mm and a width of 200 mm. Thus obtained sheet was heated from its both surfaces by a far infrared heaters (5) while being held generally horizontally by means of the guide rolls (6), and the sheet was supplied into the gap between a pair of the rolls (21, 22) each having a diameter of 100 mm. The power of the heaters was controlled such that the lamination surfaces (Sa) of the acrylic resin sheet (S) had a temperature (Ts) of 115° C. just before being sandwiched by the lamination rolls (21, 22).

On the other hand, an acrylic continuous film (F) having a single acrylic resin layer with a glass transition temperature (Tgf) of 80° C. and a thickness of 125 μm without surface treatment was unrolled from each of the two raw film material rolls (F1), and each film was passed around each of the lamination rolls (21, 22) with the contact peripheral length (C) of 40 mm. Each of such films (F) was placed on each side of the sheet (S), and the films (F) and the sheet (S) between them were sandwiched by the lamination rolls (21, 22). Heaters are installed on the lamination rolls (21, 22) respectively, and the power of the heaters was controlled such that the lamination surface (Fa) of each acrylic resin film (F) just before being sandwiched had a temperature (Tf) of 110° C.

Using a pair of the lamination rolls (21, 22), thus sandwiched acrylic resin continuous sheet (S) and the acrylic resin continuous films (F) on the both sides of the sheet (S) were pressed together with a line pressure of about 2000 N/cm so as to heat-weld them, whereby an acrylic resin laminated sheet (A) was produced in which the acrylic resin film (F) was laminated onto each surface (Sa) the acrylic resin sheet (S) as shown in FIG. 4(b). No wrinkle was observed on the films (F) of the laminated sheet (A). The sheet (A) was cut into leaves. The laminated sheet in the leaf form was cut fusing an electric saw. No delamination of the film (F) was observed across the cut section.

The conditions of the above explained Examples 1 to 5 and Comparative Example 1 are shown in the following table 1:

TABLE 1

| | acrylic resin | | acrylic resin | | |
|---|---|---|---|---|---|
| | continuous | | continuous | | |
| | sheet | | film | | |
| | Tgs(° C.) | Ts(° C.) | Tgf(° C.) | Tf(° C.) | delamination*⁾ |
| Example 1 | 105 | 115 | 80 | 110 | no |
| Example 2 | 105 | 120 | 80 | 70 | no |
| Example 3 | 105 | 130 | 105 | 110 | no |
| Example 4 | 105 | 130 | 105 | 110 | no |
| Comparative | 105 | 90 | 80 | 110 | yes |
| Example 1 | | | | | |
| Example 5 | 105 | 115 | 80 | 110 | no |

delamination*⁾: “no” means no delamination observed across cut section while “yes” means delamination observed across cut section.

What is claimed is:

1. A method for producing a thermoplastic resin laminated sheet in which a thermoplastic resin film is laminated on at least one surface of a thermoplastic resin sheet, said method comprising the steps of:
superimposing the thermoplastic resin film on the thermoplastic resin sheet which is in a heated state;
sandwiching them between a pair of lamination rolls; and
pressing them by the lamination rolls so as to heat-weld them together,
wherein, at the sandwiching step, the thermoplastic resin sheet has a lamination surface having a temperature (Ts) which satisfies the following inequality (I):
Tgs+5° C.≦Ts≦Tgs+40° C. (I)
(wherein “Ts” is a temperature of a lamination surface of the thermoplastic resin sheet, and “Tgs” is a glass transition temperature of the lamination surface of the thermoplastic resin sheet); and
the thermoplastic resin film has a lamination surface having a temperature (Tf) which satisfies the following inequalities (II) and (III):
Tgf−15° C.≦Tf≦Tgf+40° C. (II)
(wherein “Tf” is a temperature of a lamination surface of the thermoplastic resin film, and “Tgf” is a glass transition temperature of the lamination surface of the thermoplastic resin film), and
Tf≧Tgf+Tgs−Ts (III)
(wherein Ts, Tf, Tgs and Tgf are the same as defined above).

2. The method for producing the thermoplastic resin laminated sheet according to claim 1 wherein the lamination surface of the thermoplastic resin sheet comprises at least one selected from the group consisting of an acrylic resin and a methyl methacrylate-styrene copolymer resin, and the lamination surface of the thermoplastic resin film comprises at least one selected from the group consisting of an acrylic resin, a methyl methacrylate-styrene copolymer resin, a styrene resin, an acrylonitrile-butadiene-styrene terpolymer resin, a fluororesin and a nylon resin.

3. The method for producing the thermoplastic resin laminated sheet according to claim 1 wherein the thermoplastic resin film comprises a surface treatment layer on its non-lamination surface, and the pressing is carried out with a line pressure of not larger than 3000 N/m by means of the lamination rolls.

4. The method for producing the thermoplastic resin laminated sheet according to claim 3 wherein the surface treatment layer comprises a hard coat layer and/or an anti-reflection layer.

5. The method for producing the thermoplastic resin laminated sheet according to claim 1 wherein one of said pair of the lamination rolls which contacts with the thermoplastic resin film is heated, and the thermoplastic resin film is in contact with and heated by thus heated lamination roll while it is passed around the heated lamination roll, and then the thermoplastic resin film is sandwiched together with the thermoplastic resin sheet by said pair of the lamination rolls.

6. The method for producing the thermoplastic resin laminated sheet according to claim 5 wherein the thermoplastic resin film contacts with the heated lamination roll with a contact peripheral length in the range between 20 mm and 300 mm.

7. An apparatus for producing a thermoplastic resin laminated sheet in which a thermoplastic resin film is laminated on at least one surface of a thermoplastic resin sheet, which apparatus comprises:
a pair of lamination rolls by which the thermoplastic resin sheet and the thermoplastic resin film which is superimposed on the thermoplastic resin sheet are sandwiched before pressing and heat-welding them; and
a heater for heating the thermoplastic resin film, so that, at the sandwiching, the following inequalities (II) and (III) are satisfied:
Tgf−15° C.≦Tf≦Tgf+40° C. (II)
(wherein “Tf” is a temperature of a lamination surface of the thermoplastic resin film, and “Tgf” is a glass transition temperature of a lamination surface of the thermoplastic resin film), and
Tf≧Tgf+Tgs−Ts (III)
(wherein “Ts” is a temperature of a lamination surface of the thermoplastic resin sheet, and “Tgs” is a glass transition temperature of the lamination surface of the thermoplastic resin sheet, and Tf and Tgs are the same as defined above).

8. The apparatus for producing the thermoplastic resin laminated sheet according to claim 7 which further comprises a heater for heating the thermoplastic resin sheet so that, at the sandwiching, the following inequality (I) is satisfied:
Tgs+5° C.≦Ts≦Tgs+40° C. (I)

9. The apparatus for producing the thermoplastic resin laminated sheet according to claim 7 wherein the heater for heating the thermoplastic resin film is one of the lamination rolls which contacts with the thermoplastic resin film.

10. The apparatus for producing the thermoplastic resin laminated sheet according to claim 8 wherein the heater for heating the thermoplastic resin film is one of the lamination rolls which contacts with the thermoplastic resin film.

11. The apparatus for producing the thermoplastic resin laminated sheet according to claim 9 wherein the apparatus has a function such that the thermoplastic resin film contacts with the heated lamination roll with a contact peripheral length in the range between 20 mm and 300 mm.

12. The apparatus for producing the thermoplastic resin laminated sheet according to claim 10 wherein the apparatus has a function such that the thermoplastic resin film contacts with the heated lamination roll with a contact peripheral length in the range between 20 mm and 300 mm.
